(19) United States
(12) Patent Application Publication
(10) Pub. No.: US 2010/0144432 A1
(43) Pub. Date: Jun. 10, 2010

(54) LIQUID CRYSTAL DISPLAY UNIT . GAMING DEVICE ,AND DISPLAY METHOD OF LIQUID CRYSTAL DISPLAY UNIT

(76) Inventor: Eiji Nittou, Osaka (JP)

Correspondence Address: BIRCH STEWART KOLASCH & BIRCH, PO BOX 747, FALLS CHURCH, VA, 22040-0747, US

(21) Appl. No.: 12/733,167

(22) PCT Filed: Aug. 12, 2008
(86) PCT No.: PCT/JP2008/064473

§ 371 Date: Feb. 16, 2010

(30) Foreign Application Priority Data
Oct. 17, 2007 (JP) 2007-270695

(51) Int. Cl. A63F 13/00; G09G 5/10; G09G 3/36

(52) U.S. Cl. 463/30; 345/690; 345/102

(57) ABSTRACT

A light control layer (70) is provided between a first liquid crystal display element (20) and an accessory (62), and the light control layer (70) separates two regions and transmits and reflects light so that a dark region of the two regions is not seen from a bright region of the two regions and the bright region is seen from the dark region, and the two regions separated by the light control layer (70) respectively include light sources (a first light source section (40) and a second light source section (50)) whose brightnesses are independently controllable, and said liquid crystal display unit includes a control section for controlling the brightnesses of the light sources.

### TECHNICAL FIELD

The present invention relates to a liquid crystal display unit, a gaming device, and a display method of a liquid crystal display unit, and particularly to a display unit which can switch between shielding and non-shield of an accessory.

### BACKGROUND ART

Conventionally, a liquid crystal display element has been widely used as a component constituting an information display section of a gaming device such as a pachinko pinball machine.

Further, in each of recent gaming devices, the information display section is required to show not only information displayed in a liquid crystal panel of the liquid crystal display element but also an accessory or the like placed behind the liquid crystal display element. With reference to FIG. 9 schematically illustrating a configuration of a gaming device and FIG. 10 illustrating display states of an information display section of the gaming device, the following gives some explanations.

As illustrated in FIG. 9, a circular game panel 92 is provided on a front side of a gaming device 90 to show a state of a game. Further, an information display section 94 including mainly a liquid crystal display element is provided substantially at the center of the game panel 92.

The information display section 94 displays various kinds of information according to states of the game. For example, in case where the gaming device 90 is such that three numbers are interchanged according to states of the game as in a slot machine, numbers such as “567” are displayed on the liquid crystal display panel of the liquid crystal display element in the information display section 94 as illustrated in (a) of FIG. 10.

Further, in case where a combination of the three numbers is matched in a predetermined manner such as “777” as illustrated in (b) of FIG. 10, the liquid crystal display panel having displayed the numbers “777” becomes transparent. As a result, in the information display section 94, not the numbers “777” but accessories 62 (mushroom-shaped miniatures) having been placed behind the liquid crystal display element are shown in the entire screen as illustrated in (c) of FIG. 10.

That is, a player of the gaming device 90, i.e., an observer of the liquid crystal display panel alternately sees a display of the liquid crystal display panel and the accessories 62 behind the liquid crystal display panel. In another gaming device 90, the player sees both the display and the accessories at the same time.

(Patent Literature 1)

In order to realize the foregoing display, various techniques are proposed.

For example, Patent Literature 1 describes a technique using polymer dispersed liquid crystal as an LCD shutter (liquid crystal display element shutter). With reference to FIG. 11 through FIG. 14, the following gives some explanations. Here, FIG. 11 is a front view illustrating an entire configuration of a game machine (gaming device) of Patent Literature 1.

As illustrated in FIG. 11, a gaming device 101 of Patent Literature 1 includes a center case 111 positioned at the center of a game panel 106, and an image display device (liquid crystal display unit) 108 for displaying an image in the center case 111 is provided.

Specifically, as illustrated in FIG. 12 which is an exploded perspective view of the center case 111, the center case 111 includes mainly an armor section 409, the liquid crystal display unit 108, and an accessory 506 positioned behind the liquid crystal display unit 108.

Further, as illustrated in FIG. 13 which is an explanatory drawing illustrating a configuration of the liquid crystal display unit 108, the liquid crystal display unit 108 includes a first liquid crystal panel (first liquid crystal display panel) 501, a diffusion plate 502, an optical waveguide plate 503, a reflection plate 504, a liquid crystal display element shutter 505, and the like so that they are arranged substantially in parallel to one another in this order. Further, an image display LCD light source 513 is provided in a vicinity of an end of the optical waveguide plate 503 and an accessory light source 514 is provided in a vicinity of the liquid crystal display element shutter 505.

Specifically, the light source for illuminating the accessory is solely provided in the same plane as the liquid crystal display element shutter 505 is provided.

In the gaming device 101 of Patent Literature 1, the liquid crystal display element shutter 505 constituting the liquid crystal display unit 108 includes polymer dispersed liquid crystal, which allows for switching between a state where the accessory 506 can be seen and a state where the accessory 506 cannot be seen. With reference to (a) and (b) of FIG. 14 each of which is an explanatory drawing illustrating a movement principle of the polymer dispersed liquid crystal constituting the liquid crystal display element shutter 505, the following gives some explanations. Note that, (a) of FIG. 14 illustrates an orientation of liquid crystal molecules when a voltage is applied to the liquid crystal layer, and (b) of FIG. 14 illustrates an orientation of liquid crystal molecules when a voltage is not applied to the liquid crystal layer.

As illustrated in (a) and (b) of FIG. 14, in the polymer dispersed liquid crystal, a light transmittance state varies depending on whether a voltage is applied to the liquid crystal layer or not. That is, in case where a voltage is applied to the liquid crystal layer, as illustrated in (a) of FIG. 14, light passes through the polymer dispersed liquid crystal (liquid crystal display element shutter 505: ON), and the player can see the accessory 506 placed behind the liquid crystal display unit 108.

On the other hand, in case where a voltage is not applied to the liquid crystal layer, as illustrated in (b) of FIG. 14, light is scattered to appear whitish by the polymer dispersed liquid crystal (liquid crystal display element shutter 505: OFF); therefore, the player cannot see the accessory 505 placed behind the liquid crystal display unit 108.

As described above, in the gaming device 101 of Patent Literature 1, the polymer dispersed liquid crystal is used, so that it is possible to perform control for a visible state and an invisible state (a non-shielded state and a shielded state) of the accessory 506 placed behind the liquid crystal display unit 108.

Citation List

Patent Literature 1

Japanese Patent Application Publication, Tokukai, No. 2005-185624 A (Publication Date: Jul. 14, 2005)

### SUMMARY OF INVENTION

However, the conventional gaming device of Patent Literature 1 has such a problem that the accessory placed behind the liquid crystal display unit is not sufficiently shielded.

### (Shielding of the Accessory)

Specifically, in the gaming device, the accessory placed behind the liquid crystal display unit is shielded by using the polymer dispersed liquid crystal as described above. That is, as described above, light is scattered in the polymer dispersed liquid crystal to which no voltage is applied, so that the polymer dispersed liquid crystal becomes whitish, thereby shielding the accessory placed behind the polymer dispersed liquid crystal.

However, in the foregoing method, the scattering of light causes the entire unit to appear whitish. This makes an outline of the accessory blur and makes a color of the accessory appear unclear, but the player can recognize the existence of the accessory vaguely.

Thus, in case where the scattering state of the polymer dispersed liquid crystal is switched to a transmitting state so that the accessory can be clearly seen, the player is less impressed by the switching of the display since the player has recognized the existence of the accessory in the scattering state.

### (Uniformity of Display Luminance)

Further, the gaming device has such a problem that in-plane uniformity of luminance is low in the display of the liquid crystal display panel of the liquid crystal display unit.

That is, in the conventional gaming device of Patent Literature 1, as illustrated in FIG. 13, a plane of the optical waveguide plate 503 is not uniform with respect to the backlight (image display LCD light source 513) of the first liquid crystal display panel 501.

Specifically, a center of the optical waveguide plate 503 is bored. In this bored portion, light of the image display LCD light source 513 does not sufficiently illuminate the first liquid crystal display panel 501. As a result, a display at a portion corresponding to the bored portion has lower luminance than that of a peripheral portion.

However, in the configuration of the gaming device 90 of Patent Literature 1, it is essential to bore the center of the optical waveguide plate 503 so that the player can see the accessory 506. Thus, it is difficult to improve luminance of the center of the display and thus it is difficult to realize uniformity of luminance in the screen.

### (Variations of the Display)

Further, the above-described gaming device has such a problem that the number of display variations is small.

That is, in the conventional gaming device of Patent Literature 1, the player can see only two types of displays, i.e., the display of the liquid crystal display panel 501 and/or the accessory. Thus, this raises such a problem that the number of display variations of the gaming device is small.

Thus, the present invention was made in view of the foregoing problem, and an object of the present invention is to realize a liquid crystal display unit, a gaming device, and a display method of the liquid crystal display unit, all of which makes it possible to sufficiently shield an accessory placed behind a liquid crystal display element with a simple structure.

Furthermore, an object of the present invention is to realize a liquid crystal display unit, a gaming device, and a display method of the liquid crystal display unit, all of which allow for high in-plane uniformity of display luminance of a liquid crystal display panel of the liquid crystal display element and increase in the number of the display variations which can be seen by an observer of the liquid crystal display panel (a player of the gaming device).

In order to solve the foregoing problem, a liquid crystal display unit of the present invention comprises: a first liquid crystal display element for displaying an image; and an accessory provided behind the first liquid crystal display element, wherein: a light control layer is provided between the first liquid crystal display element and the accessory, the light control layer separates two regions and transmits and reflects light so that a dark region of the two regions is not seen from a bright region of the two regions, while the bright region is seen from the dark region, the two regions separated by the light control layer respectively include light sources whose brightnesses are independently controllable, and said liquid crystal display unit includes a control section for controlling the brightnesses of the light sources.

According to the foregoing configuration, the light control layer is provided between the first liquid crystal display element and the accessory. The light control layer separates two regions, and a dark region cannot be seen from a bright region. Further, in the foregoing configuration, light sources whose brightnesses can be independently controlled are respectively provided in the two regions separated by the light control layer, and a control section for controlling the brightnesses is further provided.

Thus, the brightnesses of the respective light sources are controlled so that, out of the two regions separated by the light control layer, the one region including the first liquid crystal display element is brighter than the other region including the accessory. As a result, the accessory cannot be seen by the observer of the liquid crystal display unit.

As described above, according to the foregoing configuration, it is possible to realize a liquid crystal display unit which can sufficiently shield the accessory placed behind the liquid crystal display element with such a simple structure that the light control layer is provided.

Further, it is preferable to configure the liquid crystal display unit of the present invention so that: the light control layer reflects light traveling toward the light control layer from a region including the first liquid crystal display element, said region being one of the two regions separated by the light control layer, and the light control layer allows light traveling toward the light control layer from a region including the accessory to pass through, said region being the other of the two regions separated by the light control layer.

According to the foregoing configuration, the light control layer reflects light traveling toward the light control layer from the region including the first liquid crystal display element, the region being one of the two regions separated by the light control layer, and light traveling toward the light control layer from the region including the accessory is transmitted, the region being the other of the two regions separated by the light control layer.

Thus, by controlling brightnesses of the two regions, it is possible to more reliably control a shielded state and a non-shielded state of the accessory.

That is, in case where the region including the first liquid crystal display element (liquid crystal display region) out of the two regions separated by the light control layer is made bright and the other region including the accessory (accessory region) is made dark, light emitted from the accessory region passes through the light control layer with low intensity, so that the accessory is hardly recognized by the observer of the liquid crystal display unit. In addition, light emitted from the bright liquid crystal display region is reflected by the light control layer, so that the light control layer looks like a mirror. This makes it more difficult to recognize the accessory.

Thus, it is possible to reliably shield the accessory.

Further, in case where the region including the first liquid crystal display element (liquid crystal display region) out of the two regions separated by the light control layer is made dark and the other region including the accessory (accessory region) is made bright, light emitted from the accessory can pass through the light control layer, so that the observer of the liquid crystal display unit can recognize the accessory. On the other hand, light emitted from the liquid crystal display region is reflected by the light control layer with low intensity, so that the light hardly prevents the observer from recognizing the accessory placed behind the light control layer.

Thus, it is possible to more reliably carry out non-shielding of the accessory.

As described above, the liquid crystal display unit configured in the foregoing manner can more reliably control shielding and non-shielding of the accessory.

Further, it is preferable to configure the liquid crystal display unit of the present invention so that the light control layer is realized by a magic mirror.

According to the foregoing configuration, it is possible to easily obtain a desired light control layer.

It is preferable to configure the liquid crystal display unit of the present invention so that: the light source provided in the region including the first liquid crystal display element is a first light source section serving as a backlight source of the first liquid crystal display element, and the light source provided in the region including the accessory is a second light source section for illuminating the accessory.

According to the foregoing configuration, the first light source section provided on the liquid crystal display region serves as a backlight light source of the first liquid crystal display element. This makes brighter display of the liquid crystal display element and eliminates the need for additional light source. Thus, it is possible to simplify the structure of the liquid crystal display unit.

Further, the second light source section provided on the accessory region illuminates the accessory, so that the observer can more clearly see the accessory.

It is preferable to configure the liquid crystal display unit of the present invention so that the first light source section is realized by a liquid crystal display element.

According to the foregoing configuration, the first light source section is realized by a liquid crystal display element. This makes it possible to use, as what the liquid crystal display unit displays, a display of the liquid crystal display element as well as the first liquid crystal display element and the accessory.

Thus, it is possible to increase the number of display variations of the liquid crystal display unit.

It is possible to configure the liquid crystal display unit of the present invention so that the first light source section is realized by a surface light source.

According to the foregoing configuration, the first light source section is realized by the surface light source. This makes it possible to shield a wide area covering the accessory. Thus, it is possible to more reliably shield the accessory.

Further, the first light source section is the surface light source, so that brightness of the first liquid crystal display element can be easily uniformed in using light emitted from this light source as a light source of the first liquid crystal display element.

It is preferable to configure the liquid crystal display unit of the present invention so that: a second liquid crystal display element for shielding the accessory by means of optical means is provided between the first liquid crystal display element and the light control layer.

According to the foregoing configuration, not only the light control layer but also the second liquid crystal display element is provided between the observer of the liquid crystal display unit and the accessory.

Thus, it is possible to optically shield the accessory more reliably by using the optical means.

It is preferable to configure the liquid crystal display unit of the present invention so that the second liquid crystal display element is a polymer dispersed liquid crystal display element.

According to the foregoing configuration, the second liquid crystal display element for shielding the accessory is a polymer dispersed liquid crystal display element, so that it is possible to reliably shield the accessory. Besides, by making the second liquid crystal display element transparent in showing the accessory to the observer (non-shielding of the accessory), it is possible to clearly show the accessory.

It is preferable to configure the liquid crystal display unit of the present invention so that an angle formed by the first liquid crystal display element and the light control layer is in a range of 40° to 50°.

According to the foregoing configuration, the angle formed by the first liquid crystal display element and the light control layer is around 45°, so that light emitted from the light source can be effectively used as backlight beam of the first liquid crystal display element.

Further, it is preferable that a gaming device of the present invention comprises the liquid crystal display unit.

According to the foregoing configuration, the liquid crystal display unit provided on the gaming device can sufficiently shield the accessory placed behind the first liquid crystal display element, so that it is possible to realize a game which is more impressive for a player of the gaming device.

In order to solve the foregoing problem, a display method of the present invention for a liquid crystal display unit comprising: a first liquid crystal display element for displaying an image; an accessory provided behind the first liquid crystal display element; a light control layer provided between the first liquid crystal display element and the accessory; and light sources, respectively provided in two regions separated by the light control layer, whose brightnesses are independently controllable, the light control layer controlling light so that a dark region of the two regions is not seen from a bright region of the two regions and the bright region is seen from the dark region, said liquid crystal display unit switching between (i) a display state in which an image displayed in the first liquid crystal display element is shown to an observer of the liquid crystal display unit while the accessory is shielded and (ii) a display state in which the accessory is shown to the observer without being shielded, said display method comprising the steps of: causing a first light source section which is one of the light sources and is provided in the region including the first liquid crystal display element to be brighter than a second light source section which is the other of the light sources and is provided on the region including the accessory, in carrying out display in the display state (i); and causing the second light source section to be brighter than the first light source section, in carrying out display in the display state (ii), whereby the switching between the display states (i) and (ii) is carried out.

According to the foregoing method, as described above, brightnesses of the two regions (the region including the first liquid crystal display element (liquid crystal display region) and the region including the accessory (accessory region)) are adjusted by controlling the light sources (the first light source section and the second light source section) provided on the respective regions, thereby controlling shielding and non-shielding of the accessory.

Thus, according to the foregoing method, it is possible to realize a display method of a liquid crystal display unit which makes it possible to sufficiently shield the accessory placed behind the liquid crystal display element, with a simple structure.

As described above, the liquid crystal display unit of the present invention is configured so that: the light control layer is provided between the first liquid crystal display element and the accessory, and the light control layer separates the two regions, and the light control layer transmits and reflects light so that the dark region of the two regions is not seen from the bright region and the bright region is seen from the dark region, and the two regions separated by the light control layer respectively include light sources whose brightnesses are independently controllable, and said liquid crystal display unit includes a control section for controlling the brightnesses of the light sources.

Further, as described above, the display method of the present invention for a liquid crystal display unit is a display state switching method configured so that: the first light source section provided on the region including the first liquid crystal display element is made brighter than the second light source section provided on the region including the accessory in showing an image displayed in the first liquid crystal display device while the accessory is shielded, and the second light source section is made brighter than the first light source section in showing the accessory without shielding the accessory.

Therefore, it is possible to realize, with a simple structure, a liquid crystal display unit and a display method of a liquid crystal display unit both of which makes it possible to sufficiently shield the accessory placed behind the liquid crystal display element.

### BRIEF DESCRIPTION OF DRAWINGS

FIG. 1 is a perspective view which schematically illustrates a configuration of a liquid crystal display unit of an embodiment of the present invention when viewed from a front direction.

FIG. 2 is a perspective view which schematically illustrates a configuration of a liquid crystal display unit of an embodiment of the present invention when viewed from a backside direction.

FIG. 3 is a cross sectional view schematically illustrating a configuration of a liquid crystal display section of a liquid crystal display unit of the present invention.

FIG. 4 illustrates a liquid crystal display unit of an embodiment of the present invention, wherein (a) illustrates a display that can be seen by an observer, and (b) illustrates a side face of the liquid crystal unit which side face corresponding to the state illustrated in (a).

FIG. 5 illustrates a liquid crystal display unit of an embodiment of the present invention, wherein (a) illustrates a display that can be seen by an observer, and (b) illustrates a side face of the liquid crystal unit which side face corresponding to the state illustrated in (a).

FIG. 6 illustrates a liquid crystal display unit of an embodiment of the present invention, wherein (a) illustrates a display that can be seen by an observer, and (b) illustrates a side face of the liquid crystal unit which side face corresponding to the state illustrated in (a).

FIG. 7 illustrates a liquid crystal display unit of an embodiment of the present invention, wherein (a) illustrates a display that can be seen by an observer, and (b) illustrates a side face of the liquid crystal unit which side face corresponding to the state illustrated in (a).

FIG. 8 is a block diagram schematically illustrating a configuration of a liquid crystal display unit of an embodiment of the present invention.

FIG. 9 schematically illustrates a gaming device.

FIG. 10 illustrates a display in an information display section of the gaming device.

FIG. 11 is a front view illustrating an entire configuration of the gaming device described in Patent Literature 1.

FIG. 12 is an exploded perspective view illustrating a configuration of a center case of the gaming device described in Patent Literature 1.

FIG. 13 is an explanatory drawing illustrating a configuration of a liquid crystal display unit of the gaming device described in Patent Literature 1.

FIG. 14 illustrates principle of movement of polymer dispersed liquid crystal of a liquid crystal display element shutter of the gaming device described in Patent Literature 1, wherein (a) illustrates an orientation of liquid crystal molecules when a voltage is applied, and (b) illustrates an orientation of liquid crystal molecules when a voltage is not applied.

### REFERENCE SIGNS LIST

1. Liquid crystal display unit

10. Liquid crystal display section

20. First liquid crystal display element

30. Second liquid crystal display element

40. First light source section

45. Third liquid crystal display element

50. Second light source section

62. Accessory

70. Light control layer

80. Main control section (control section)

90. Gaming device

### DESCRIPTION OF EMBODIMENTS

One embodiment of the present invention is described below with reference to the attached drawings.

### (Configuration of Liquid Crystal Display Unit)

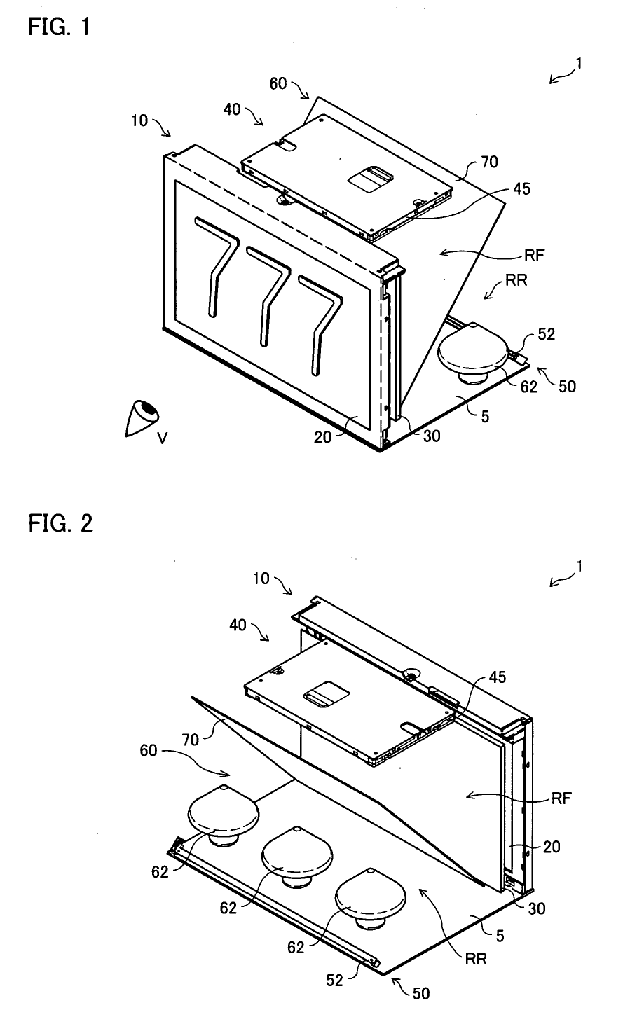

First, a schematic configuration of a liquid crystal display unit 1 of the present embodiment is described as follows with reference to FIG. 1 and FIG. 2. Each of FIG. 1 and FIG. 2 is a perspective view schematically illustrating the liquid crystal display unit 1 of the present embodiment. FIG. 1 illustrates the liquid crystal display unit 1 seen from a front direction. FIG. 2 illustrates the liquid crystal display unit 1 seen from a backside direction.

As illustrated in FIG. 1, the liquid crystal display unit 1 of the present embodiment includes a liquid crystal display section 10, an accessory 60, and a main control section (not shown: including a control section for controlling brightnesses of light sources).

### (Entire Configuration of Liquid Crystal Display Section)

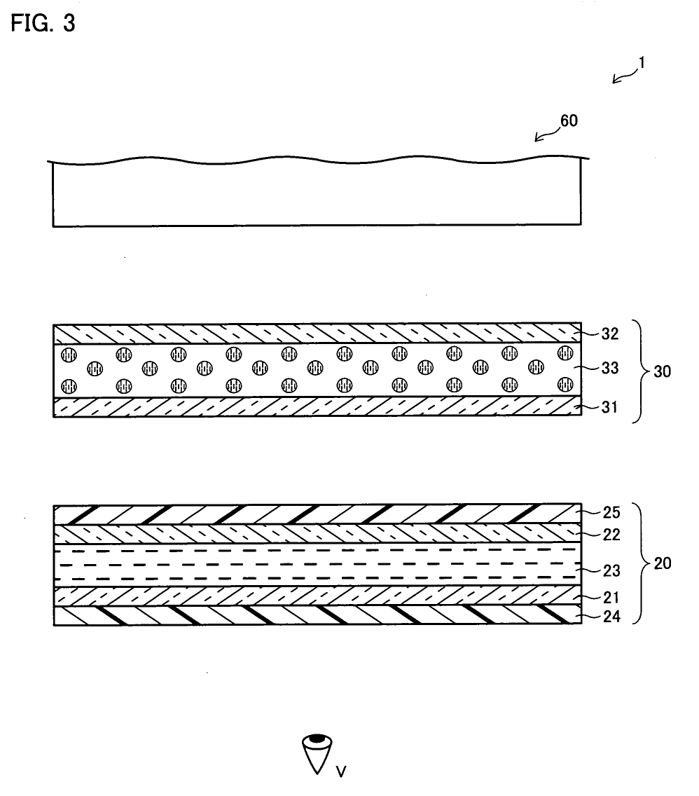

First, with reference to FIG. 1, FIG. 2, and FIG. 3, a liquid crystal display section 10 of the present embodiment is described as follows. Note that, FIG. 3 is a cross sectional view schematically illustrating a configuration of the liquid crystal display section 10 of the liquid crystal display unit 1 of the present embodiment.

The liquid crystal display section 10 of the present embodiment includes two liquid crystal display elements, i.e., a first liquid crystal display element 20, a second liquid crystal display element 30, and a third liquid crystal display element 45.

### (First Liquid Crystal Display Element and Second Liquid Crystal Display Element)

Further, the first liquid crystal display element 20 and the second liquid crystal display element 30 are provided on the front side of the liquid crystal display unit 1, and the first liquid crystal display element 20 and the second liquid crystal display element 30 are combined to each other so that the first liquid crystal display element 20 faces an observer of the liquid crystal display unit 1 (see an observer V of FIG. 3) and the second liquid crystal display element 30 faces the accessory 60.

Here, the first liquid crystal display element 20 is an image display liquid crystal display element which displays an image content concerning a game required to be displayed in the liquid crystal panel to the observer V.

On the other hand, from a view point of the observer V, the second liquid crystal display element 30 is placed behind the first liquid crystal display element 20 and is provided in front of an accessory 62 so as to serve as a shutter liquid crystal element for switching between shielding and non-shielding of the accessory 62. The following describes the respective components.

### (First Liquid Crystal Display Element)

First, the first liquid crystal display element 20 is described.

The first liquid crystal display element 20 includes a general liquid crystal display element, e.g., an active matrix liquid crystal display element or the like in which a TFT (Thin Film Transistor) is formed on each pixel.

A layer arrangement of the first liquid crystal display element 20 is such that: as illustrated in FIG. 3, a liquid crystal layer 23 is provided between two substrates (a first substrate 21 and a second substrate 22), and a first polarization plate 24 is provided on the side of the first substrate 21 (outer surface) opposite to the side thereof facing the liquid crystal layer 23, and a second polarization plate 25 is provided on the side of the second substrate 22 (outer surface) opposite to the side thereof facing the liquid crystal layer 23.

As described above, the first liquid crystal display element 20 displays an image or the like concerning the content of a game or the like to show it to the observer V of the liquid crystal display unit 1, e.g., a player in case where the liquid crystal display unit 1 is used for a gaming device.

### (Second Liquid Crystal Display Element)

Next, the second liquid crystal display element 30 is described.

In the present embodiment, the second liquid crystal display element 30 is realized by a so-called polymer dispersed liquid crystal display element.

Specifically, a liquid crystal layer 33 is provided between two substrates (a first substrate 31 and a second substrate 32), and a polymer dispersed liquid crystal layer is used as the liquid crystal layer 33. Further, the liquid crystal layer 33 has a polymer-based three-dimensional network formed therein, and liquid crystal molecules are introduced into voids of the network.

Further, a polarization plate is not provided on the second liquid crystal display element 30.

### Light Scattering State

As described above, the second liquid crystal display element 30 of the polymer dispersed type is such that: when a voltage is not applied to the liquid crystal layer 33, the liquid crystal molecules are randomly oriented, which causes a scattering of light in the liquid crystal layer 33.

Thus, when a voltage is not applied, light resists passing through the liquid crystal layer 33, so that a ratio of reflecting light increases. Further, light having passed through the liquid crystal layer 33 scatters in the liquid crystal layer 33 and thus becomes white scattering light.

Thus, when a voltage is not applied to the liquid crystal layer 33, an object (for example, the accessory 62) placed behind the second liquid crystal display element 30 cannot be seen or can be seen so that the object appears to be white and blurred in outline.

### 2) Transparent State

On the other hand, when a voltage is applied to the liquid crystal layer 33, the liquid crystal molecules are aligned together in one direction along an electric field generated by the voltage. That is, the state in which the liquid crystal molecules are randomly aligned changes into the state in which the liquid crystal molecules are uniformly aligned.

Thus, light passes through the liquid crystal layer 33 without scattering.

Therefore, the second liquid crystal display element 30 becomes transparent, so that the object (for example, the accessory 62) placed behind the second liquid crystal display element 30 is clearly seen.

### (Configuration of Third Liquid Crystal Display Element)

As illustrated in FIG. 1 and FIG. 2, the liquid crystal display unit 1 includes not only the first liquid crystal display element 20 and the second liquid crystal display element 30 but also a third liquid crystal display element 45. As described below, the third liquid crystal display element 45 serves also as a first light source section 40.

The third liquid crystal display element 45 has a substantially rectangular shape, and a schematic configuration thereof is the same as that of the first liquid crystal display element 20.

Specifically, as a liquid crystal display panel provided on the third liquid crystal display element 45, it is preferable to use an active matrix liquid crystal display panel in which a TFT (thin film transistor) is formed in each pixel as a switching element. Further, a general backlight is provided behind the liquid crystal display panel.

Here, the general backlight is, for example, a backlight which is provided with a lamp as a light source, an optical waveguide plate, a diffusion plate, and the like, and which illuminates the liquid crystal display panel from behind it so as to function as a surface light source.

Note that, in the present embodiment, as illustrated in FIG. 1 and FIG. 2, the third liquid crystal display element 45 smaller in size than the first liquid crystal display element 20 is described as an example. However, a size of the third liquid crystal display element 45 is not limited to this size.

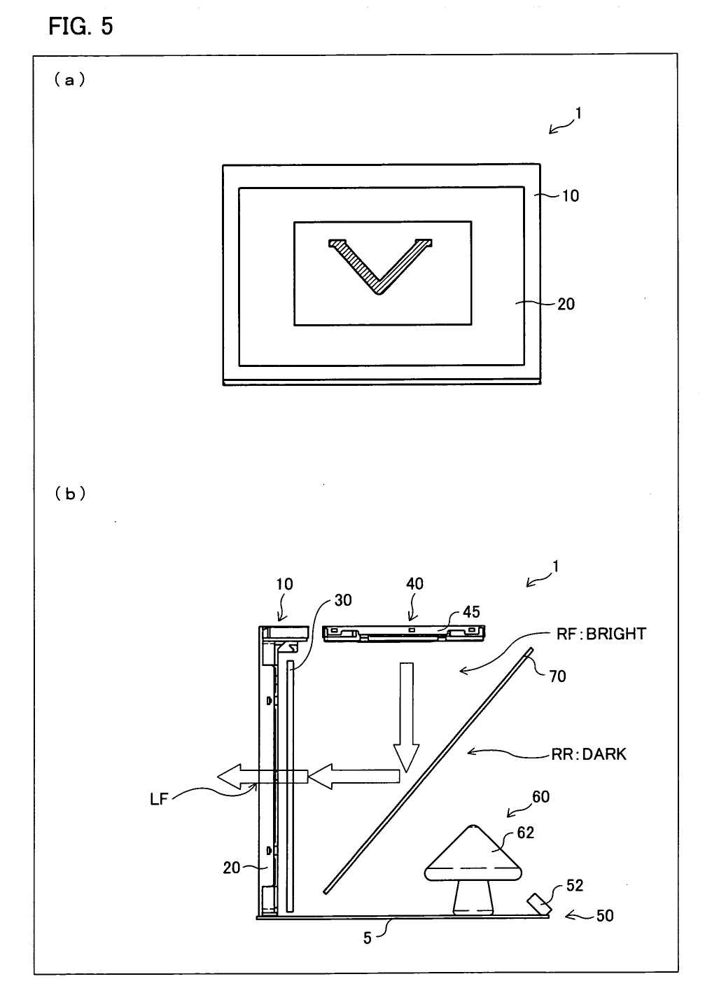

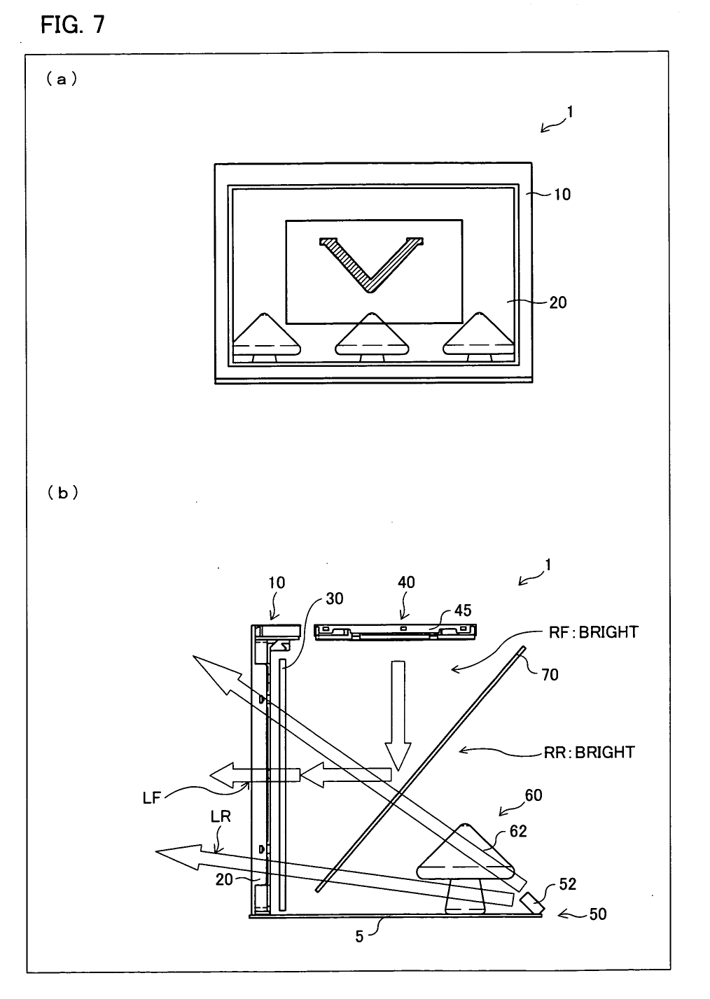

As illustrated in FIG. 1 and the like, in case where the third liquid crystal display element 45 is made smaller than the first liquid crystal display element 20, as described below with reference to (a) of FIG. 5 and the like, what the third liquid crystal display element 45 displays can be displayed in only a part of the liquid crystal display section 10, and as illustrated in (a) of FIG. 7, what the third liquid crystal display element 45 displays and the accessory 62 can be easily shown at the same time.

(Place where Third Liquid Crystal Display Element is Provided)

Next, a place where the third liquid crystal display element 45 is provided is described.

As illustrated in FIG. 1 and FIG. 2, the third liquid crystal display element 45 is provided on the liquid crystal display unit 1 so as to be positioned behind the first liquid crystal display element 20 and the second liquid crystal display unit 30 and forward of the accessory 62 (nearer to the first liquid crystal display element 20 than the accessory 62).

Specifically, the third liquid crystal display element 45 having a substantially rectangular shape has one side which is in contact with one side of the first liquid crystal display element 20 (an upper and longer side of the first liquid crystal display element 20 when provided on the liquid crystal display unit 1), and the third liquid crystal display element 45 forms a certain angle with respect to the first liquid crystal display element 20 unlike the second liquid crystal display element 30.

Specifically, the third liquid crystal display element 45 is provided so that one longer side thereof is in contact with an upper side of the first liquid crystal display element 20 and the third liquid crystal display element 45 forms an angle of nearly 90° with respect to the first liquid crystal display element 20.

### (Accessory Section)

Next, the accessory section 60 of the liquid crystal display unit 1 of the present embodiment is described.

The accessory section 60 is provided on the liquid crystal display unit 1 so as to be positioned behind the aforementioned liquid crystal display section 10.

Further, the accessory section 60 includes mainly the accessories 62 and also includes a second light source 50.

### (Accessory)

Here, the accessory 62 refers to a model or the like required to be directly seen by the observer V of the liquid crystal display unit 1, for example, including a miniature of a human, a character, a vehicle, or the like. In the present embodiment, three mushroom-shaped miniatures are used as the accessories 62.

### (Second Light Source Section)

Next, the second light source section 50 is described.

As illustrated in FIG. 1 and FIG. 2, the second light source section 50 is provided behind the accessories 62, in other words, provided in a vicinity of a backend of the liquid crystal display unit 1. Further, the second light source section 50 includes a second light source lamp 52 for mainly illuminating the accessories 62.

As described above, the accessory section 60 of the present embodiment mainly includes the accessories 62 and the second light source lamp 52.

### (Light Control Layer)

Further, in the liquid crystal display unit 1 of the present embodiment, a light control layer 70 is provided between the liquid crystal display section 10 and the accessory section 60.

Here, the light control layer 70 means a layer which adjusts brightnesses of respective light sources (the first light source section, the second light source section, and the like) provided on the liquid crystal display unit 1 or carries out a similar operation so as to switch between a visible state and an invisible state of the accessories 62 (shielded state and non-shielded state of the accessories 62) for the observer V.

Specifically, for example, a layer including a magic mirror (half mirror) is used.

### (How to Provide the Light Control Layer)

In the present embodiment, a magic mirror serving as the light control layer 70 is provided so as to form an angle of nearly 45° with respect to a unit bottom 5 of the liquid crystal display unit 1.

More specifically, the magic mirror has a substantially rectangular shape and its length in a longitudinal direction (horizontal direction) is substantially the same as that of the first liquid crystal display element 20 of the liquid crystal display section 10.

Further, a lower side of the magic mirror and a lower side of the liquid crystal display section 10 are placed to be substantially aligned. Further, an upper side of the magic mirror is fixed to be located in a rearward position of the liquid crystal display unit 1, that is, fixed to be inclined toward the accessory 62, so that the magic mirror forms an angle of 45° with respect to the unit bottom 5.

Further, an area inside the liquid crystal display unit 1 has two regions separated by the light control layer 70 (magic mirror).

Out of the two regions, a front region of the liquid crystal display unit 1, i.e., a region including the liquid crystal display section 10 serves as a front region RF.

While, the other region is a rear region of the liquid crystal display unit 1 and serves as a rear region (RR) including the accessory section 60.

Note that, an angle which the magic mirror forms with the unit bottom 5 is not limited to 45° and can be set to any angle as appropriate. Here, in case where the angle is set to around 45°, light emitted from the first light source section 40 positioned in an upper region of the liquid crystal display unit 1 can be effectively used as backlight light of the first liquid crystal display element 20.

That is, light emitted from the first light source section 40 is reflected by the magic mirror serving as the light control layer 70 and travels in a direction substantially parallel to the unit bottom 5, so that the light is substantially perpendicularly directed into the first liquid crystal display element.

### (Magic Mirror)

Next, the magic mirror used as the light control layer 70 of the present embodiment is described.

Here, the magic mirror refers to the following layer. For example, assume that there is a brightness difference between both sides (two regions) sandwiching the mirror. In this case, the magic mirror appears to be like a mirror when seen from a bright region, so that a dark region behind the magic mirror cannot be seen. Meanwhile, the bright region can be clearly seen when seen from the dark region. A layer exhibiting such effect serves as the magic mirror.

Generally, light is reflected by a surface of the magic mirror, and the backside region of the magic mirror (opposite region) cannot be seen, and in case where light having certain intensity is illuminated from the backside of the magic mirror (from a side opposite to an observer with the magic mirror therebetween), the light passes through the surface side (the side which faces the observer). The magic mirror herein uses this property.

In other words, light which travels from the bright region toward the magic mirror is reflected by the surface of the magic mirror rather than passes through the magic mirror. Thus, the magic mirror appears to be like a mirror for the observer, and the region behind the magic mirror is hardly seen. Meanwhile, light which travels from the dark region toward the magic mirror is hardly reflected by the surface of the magic mirror and passes through the magic mirror toward the bright region.

Due to the foregoing property, an object in the dark region is hardly seen when seen from the bright region through the magic mirror, while an object in the bright region is easily seen when seen from the dark region through the magic mirror.

### (Structure of the Magic Mirror, Optical Property)

A structure of the magic mirror used in the present embodiment is not particularly limited. For example, a reflection film is formed on a transparent substrate such as glass, and in forming the reflection film by depositing metal or by carrying out a similar operation, the reflection film is made thinner so that not only reflectivity but also transmissivity is given to the reflection film. An optical material obtained in this manner is favorably used.

Further, it is possible to use an optical material to which reflectivity and transmissivity are imparted by depositing plural types of metallic materials on the substrate.

Here, balance between the reflectivity and the transmissivity, in other words, percentages of reflectivity and transmissivity of the optical material are not particularly limited. Depending on a purpose of use, for example, each of the percentages can be set between 0% and 100%, for example the percentage can be set to be in a range from 5% to 80%. A sum of the percentages of reflectivity and transmissivity ranges, for example, from 30% to 70%.

Above all, in the present embodiment, an optical material whose percentage of transmissivity is around 10% is favorably used.

### (Light Source Section)

As described above, in the present embodiment, there is a brightness difference between both regions (the front region RF and the rear region RR) with the magic mirror therebetween, which makes it possible to control what the magic mirror as the light control layer appears to be like. A mechanism of the display will be described later. The following describes two light source sections (the first light source section 40 and the second light source section 50) which are prerequisites to display control of the light control layer 70.

### (Second Light Source Section)

First, the second light source section 50 is a light source for controlling brightness of the rear region RR, which is a region behind the magic mirror.

As described above, the second light source section 50 includes the second light source lamp 52. Further, the second light source lamp 52 is capable of illuminating the accessories 62 and adjusting brightness of the rear region RR.

### (First Light Source Section)

On the other hand, the first light source section 40 is a light source for controlling brightness of the front region RF, which is a region in front of the magic mirror.

In the present embodiment, as described above, the first light source section 40 does not particularly include any special light source lamp which functions only as a light source, and the first light source section 40 is provided with the third liquid crystal display element 45, as a light source lamp, configured in substantially the same manner as in a liquid crystal display element for a general display.

Further, the third liquid crystal display element 45 includes the backlight as described above. Further, in accordance with light emitted from the backlight, brightness of the front region RF is controlled.

For example, in case where the third liquid crystal display element 45 entirely emits the light (entire white display), the front region RF is bright, and in case where the third liquid crystal display element 45 entirely puts off the light (entire black display), the front region RF is dark. Further, a halftone is displayed in the third liquid crystal display element 45, so that brightness of the front region RF can be adjusted as appropriate.

Note that, as described above, the third liquid crystal display element 45 of the present embodiment is substantially rectangular, and a size thereof is smaller than the first liquid crystal display element 20.

A size and a shape of the liquid crystal display element serving as a light source lamp are not particularly limited.

However, as described above, light emitted from the first light source section 40 of the present embodiment is reflected by the light control layer 70, so that the first light source section 40 serves also as a backlight source of the first liquid crystal display element 20.

Thus, it is preferable that the third liquid crystal display element 45 has a large area size, and it is particularly preferable that the third liquid crystal display element 45 has the same shape as that of the first liquid crystal display element 20. Thus, the third liquid crystal display element 45 is likely to act as a surface light source of the first liquid crystal display element 20, which enables the first liquid crystal display element 20 to perform display with small in-plane luminance unevenness.

Further, the light source lamp provided on the first light source section 40 is not limited to the configuration in which the liquid crystal display element is used. For example, a lamp such as a fluorescent lamp can be used as the light source lamp.

In this case, it is preferable not to use only one striplight but to use a lamp which can constitute a surface light source in combination with a peripheral member such as an optical waveguide plate, a diffusion plate, and the like. This enables, as in the foregoing configuration, the first liquid crystal display element 20 to perform display with small in-plane luminance unevenness.

### (Mechanism of Display)

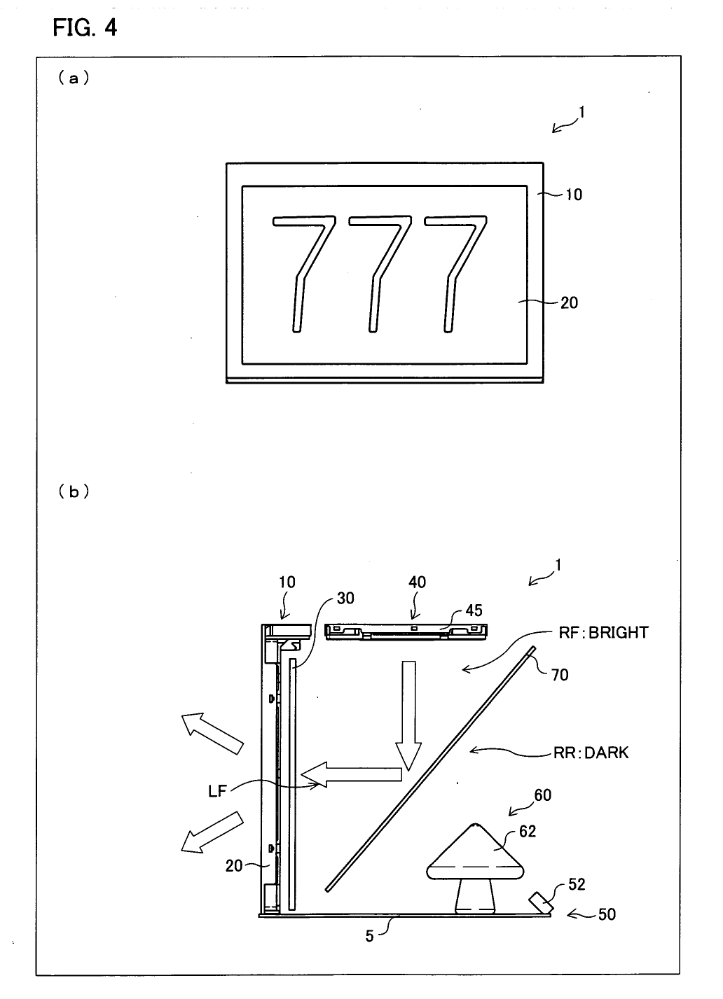

Next, with reference to FIG. 4 through FIG. 7, a mechanism of a display in the display unit 1 of the present embodiment is described.

Here, (a) of FIG. 4 through (a) of FIG. 7 are drawings each of which illustrates what the observer V can view on the liquid crystal display unit 1 of the present embodiment.

Further, (b) of FIG. 4 through (b) of FIG. 7 are drawings each of which schematically illustrates a side face of the liquid crystal display unit 1 of the present embodiment.

In the liquid crystal display unit 1 of the present embodiment, the third liquid crystal display element 45 provided on the first light source section 40 as a light source can display characters and the like, so that various types of display can be carried out. The following describes typical display variations.

### (Display Carried Out by the First Liquid Crystal Display Element (Display Mode 1))

First, with reference to (a) of FIG. 4 and (b) of FIG. 4, the first display mode of the present invention is described. Here, (a) of FIG. 4 and (b) of FIG. 4 are drawings each of which illustrates a state in which the liquid crystal display unit 1 shows, to the observer, what the first liquid crystal display element 20 displays.

In this display mode, the first liquid crystal display element 20 displays “777”, the second liquid crystal display element 30 serving as a shutter liquid crystal element is in a light scattering state (shielded state), the third liquid crystal display element 45 is in an entire white display state, and the second light source lamp 52 of the second light source section 50 serving as a backside light source is in an off state.

If the respective sections of the liquid crystal display unit 1 are set to be in the foregoing states, the liquid crystal display unit 1 shows what the first liquid crystal display element 20 displays, as illustrated in (a) of FIG. 4.

With reference to (b) of FIG. 4, the following describes how such display is carried out.

That is, in this display mode, the two regions, the front region RF and the rear region RR, separated by the light control layer 70 are as follows. In the first light source section 40 of the front region RF, the third liquid crystal display element 45 emits light in an entire white display state. While, in the second light source section 50 of the rear region RR, the second light source lamp 52 does not emit light. Thus, comparison in brightness between the front region RF and the rear region RR shows that the front region RF is brighter than the rear region RR.

As a result, the rear region RR cannot be seen from the brighter front region RF as described above, so that the observer cannot see the accessory 62 positioned in the rear region RR.

On the other hand, light emitted from the third liquid crystal display element 45 which is in an entire white display state is reflected by the light control layer 70, and the light travels toward the second liquid crystal display element 30 (see an arrow LF in (b) of FIG. 4).

Further, as light emitted from the surface light source (backlight of the third liquid crystal display element), light which has certain breadth in advance and is emitted from the third liquid crystal display element 45 passes through the second liquid crystal display element 30 in a light scattering state, or the light is repeatedly scattered and reflected in the second liquid crystal display element 30. As a result, the light becomes backlight light having high in-plane uniformity and reaches the first liquid crystal display element 20.

Further, such light serves as backlight beam of the first liquid crystal display element 20, so that the observer can see “777” displayed in the first liquid crystal display element 20.

In case where the second liquid crystal display element 30 is substantially as large as the first liquid crystal display device 20, the observer can see an image having higher in-plane uniformity in terms of brightness.

As described above, in the display mode, the third liquid crystal display element 45 carries out entire white display, thereby improving display luminance of the first liquid crystal display element 20.

Further, the second liquid crystal display element 30 is in a light scattering state, so that the accessories 62 are shielded from the observer and in-plane uniformity of backlight beam for the first liquid crystal display element is improved.

Further, the light control layer 70 shields the accessories 62 from the observer since the rear region RR is darker than the front region FR.

### (Display Carried Out by the Third Liquid Crystal Display Element (Display Mode 2))

Next, with reference to (a) of FIG. 5 and (b) of FIG. 5, the second display mode of the present invention is described. Here, (a) of FIG. 5 and (b) of FIG. 5 are drawings each of which illustrates a state in which the liquid crystal display unit 1 shows, to the observer, what the third liquid crystal display element 45 displays.

In this display mode, the first liquid crystal display element 20 in an entire white display state (transparent state), the second liquid crystal display element 30 serving as a shutter liquid crystal element is in a transparent state (non-shielded state), the third liquid crystal display element 45 displays a character “V”, and the second light source lamp of the second light source section 50 serving as a backlight source does not emit light.

If the respective sections of the liquid crystal display unit 1 are set in the foregoing states, the liquid crystal display unit 1 displays a display content of the third liquid crystal display element 45 as illustrated in (a) of FIG. 5.

With reference to (b) of FIG. 5, how such display is carried out is described.

That is, in this display mode, the two regions, the front region RF and the rear region RR, separated by the light control layer 70 are as follows. In the first light source section 40 of the front region RF, the third liquid crystal display element 45 emits light while displaying “V”. While, in the second light source section 50 of the rear region RR, the second light source lamp 52 does not emit light. Thus, comparison in brightness between the front region RF and the rear region RR shows that the front region RF is brighter than the rear region RR.

As a result, as in the case of the aforementioned display mode 1, the darker rear region RR cannot be seen from the brighter front region RF. Thus, the observer cannot see the accessories 62 positioned in the rear region RR.

On the other hand, light emitted from the third liquid crystal display element 45 displaying “V” is reflected by the light control layer 70 and travels toward the second liquid crystal display element 30 (see an arrow LF in (b) of FIG. 5).

At this time, in the present embodiment, the light control layer 70 is a magic mirror, so that light indicative of the character “V” emitted from the third liquid crystal display element 45 is reflected by a surface of the magic mirror, so that the display of “V” reaches the second liquid crystal display element 30 without distortion.

Further, the second liquid crystal display element 30 is in a light transmittance state, so that the display of “V” (light indicative of “V”) reaches the first liquid crystal display element 20 as it is.

Further, the first liquid crystal display element 20 is in a white display state, that is, in a state allowing light to pass, so that the light indicative of “V” reaches the observer as it is.

As a result, the observer can see “V” displayed in the third liquid crystal display element 45.

As described above, in this display mode, the third liquid crystal display element 45 carries out any desired display (the display of “V” in the present embodiment) and allows the observer to see the display of “V”, so that display variations of the liquid crystal display unit 1 increase.

Further, each of the first liquid crystal display element 20 and the second liquid crystal display element 30 is in a light transmittance state, so that the observer can see what the third liquid crystal display element 45 displays as it is.

Further, the light control layer 70 shields the accessories 62 from the observer since the rear region RR is darker than the front region FR.

As explained in the descriptions of the two display modes, the third liquid crystal display element 45 of the present embodiment functions as a light source (display mode 1) and also functions as an information-offering display for increasing variations of the display (display mode 2).

### (Display of Accessories (Display Mode 3)

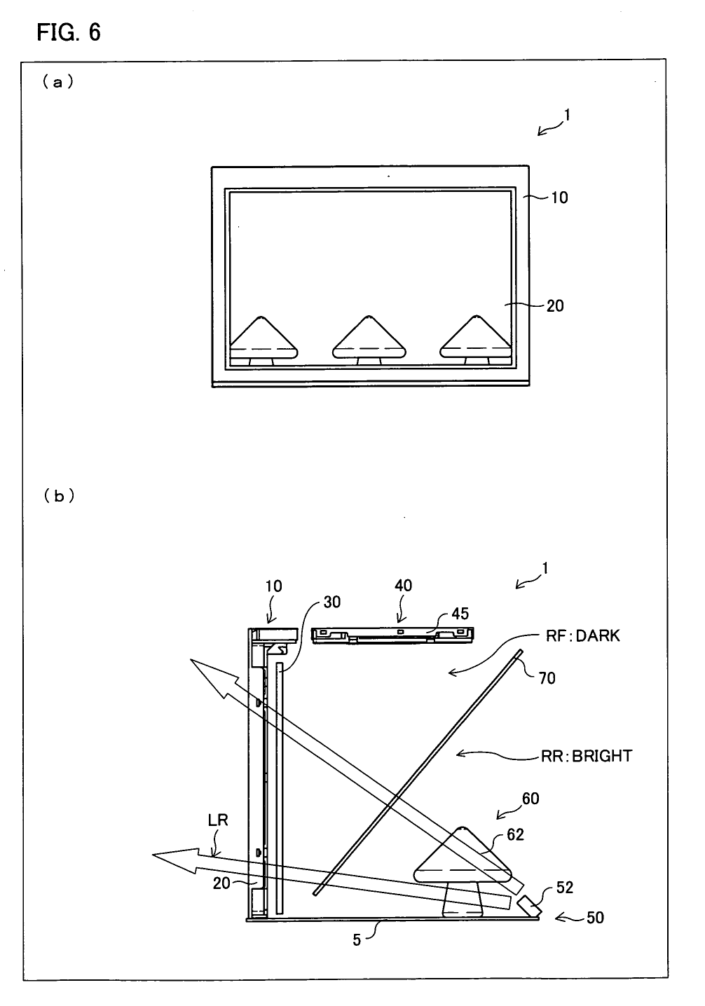

Next, with reference to (a) of FIG. 6 and (b) of FIG. 6, a third display mode of the present invention is described. Here, (a) of FIG. 6 and (b) of FIG. 6 are drawings each of which illustrates a state in which the liquid crystal display unit 1 shows the accessories 62 to the observer.

In this display mode, the first liquid crystal display element 20 is in an entire white display state (transmission state), and the second liquid crystal display element 30 serving as a shutter liquid crystal element is in a transmission state (unshielded state), and the third liquid crystal display element 45 is in an off state (entire black display state), and the second light source lamp 52 of the second light source section 50 serving as a backside light source is in an illumination (light emission) state.

If the respective sections of the liquid crystal unit 1 are set in the foregoing states, the liquid crystal display unit 1 displays the accessories 62 (the accessories 62 can be seen) as illustrated in (a) of FIG. 6.

With reference to (b) of FIG. 6, how such display is carried out is described.

That is, in the display mode, the two regions, the front region RF and the rear region RR, separated by the light control layer 70 are as follows. In the first light source section 40 of the front region RF, the third liquid crystal display element 45 does not emit light. While, in the second light source section 50 of the rear region RR, the second light source lamp 52 illuminates (emits light). Thus, comparison in brightness between the front region RF and the rear region RR shows that the rear region RR is brighter than the front region RF.

As a result, unlike the aforementioned two display modes 1 and 2, the brighter rear region RR can be seen from the darker front region RF. Thus, the observer can see the accessories 62 positioned in the rear region RR (see an arrow LR in (b) of FIG. 6).

Further, the first liquid crystal display element 20 and the second liquid crystal display element 30 are in a transmission state, so that the observer can clearly see the accessories 62 without being shielded by the first liquid crystal display element 20 and the second liquid crystal display element 30.

As described above, in this display mode, the third liquid crystal display element 45 of the first light source section 40 does not emit light and the second light source lamp 52 of the second light source section 50 illuminates. Thus, the light control layer 70 does not shield the accessories 62 from the observer since the front region RF is darker than the rear region RR. Further, as described above, the first liquid crystal display element 20 and the second liquid crystal display element 30 do not shield the accessories 62 from the observer.

As a result, the observer can clearly see the accessories 62.

### (Display of the Accessories (Display Mode 4))

Next, with reference to (a) of FIG. 7 and (b) of FIG. 7, a fourth display mode of the present invention is described. Here, (a) of FIG. 7 and (b) of FIG. 7 are drawings each of which illustrates a state in which the liquid crystal display unit 1 shows, to the observer, (i) what the third liquid crystal display element displays and (ii) the accessory 62, together.

In this display mode, the first liquid crystal display element 20 is in an entire white display state (transmission state), and the second liquid crystal display element 30 serving as shutter liquid crystal element is in a transmission state (unshielded state), and the third liquid crystal display element 45 displays “V”, and the second light source lamp 52 of the second light source section 50 serving as a backside light source is in an illumination (light emission) state.

If the respective sections of the liquid crystal display unit 1 are set in the foregoing states, as illustrated in (a) of FIG. 7, the liquid crystal display unit 1 shows the accessories 62 (the accessories can be seen) and also shows “V” displayed in the third liquid crystal display element 45.

With reference to (b) of FIG. 7, how such display is carried out is described.

That is, in this display mode, the two regions, the front region RF and the rear region RR, separated by the light control layer 70 are as follows. In the first light source section 40 of the front region RF, the third liquid crystal display element 45 displays “V”, but brightness decreases compared with the entire white display. While, in the second light source section 50 of the rear region RR, the second light source lamp 52 illuminates (emits light).

Thus, comparison in brightness between the front region RF and the rear region RR shows that the rear region RR is brighter than the front region RF.

As a result, as in the case of the aforementioned display mode 3, the brighter rear region RR can be seen from the darker front region RF. Thus, the observer can see the accessories 62 positioned in the rear region RR (see an arrow LR in (b) of FIG. 7).

Further, both the first liquid crystal display element 20 and the second liquid crystal display element 30 are in a transparent state, so that the observer can clearly see the accessories 62 without being shielded by the first liquid crystal display element 20 and the second liquid crystal display element 30.

Besides, in this display mode, the observer can also see “V” displayed in the third liquid crystal display element 45.

That is, light emitted from the third liquid crystal display element 45 displaying “V” is reflected by the light control layer 70 and travels toward the second liquid crystal display element 30 (see an arrow LF in (b) of FIG. 7).

At this time, as in the case of the aforementioned display mode 2, the light control layer 70 is a magic mirror. Thus, the light indicative of “V” emitted from the third liquid crystal display element 45 is reflected by a surface of the magic mirror, so that the display of “V” reaches the second liquid crystal display element 30 without distortion.

Further, the second liquid crystal display element 30 is in a light transmittance state, so that the display of “V” (light indicative of “V”) reaches the first liquid crystal display element 20 as it is.

Further, the first liquid crystal display element 20 is in a white display state, that is, in a state allowing light to be transmitted, so that the light indicative of “V” reaches the observer as it is.

As a result, the observer can see not only the accessories 62 but also “V” displayed in the third liquid crystal display element 45.

As described above, in this display mode, the third liquid crystal display element 45 of the first light source section 40 carries out display but the display is not an entire white display. On the other hand, the second light source lamp 52 of the second light source section 50 illuminates. Thus, the light control layer 70 does not shield the accessories 62 from the observer since the front region RF is darker than the rear region RR. Further, as described above, also the first liquid crystal display element 20 and the second liquid crystal display element 30 do not shield the accessories 62 from the observer.

As a result, the observer can clearly see the accessories 62.

Further, what the third liquid crystal display element 45 displays is not shielded from the observer likewise, so that the observer can also see what the third liquid crystal display element 45 displays.

Note that, each of the aforementioned display modes is a typical exemplary display mode. Additionally, other variations are applicable. For example, what the first liquid crystal display element 20 displays and what the third liquid crystal display element 45 displays may be concurrently displayed, and what the first liquid crystal display element 20 displays and the accessories 62 may be concurrently displayed.

### (Entire Configuration)

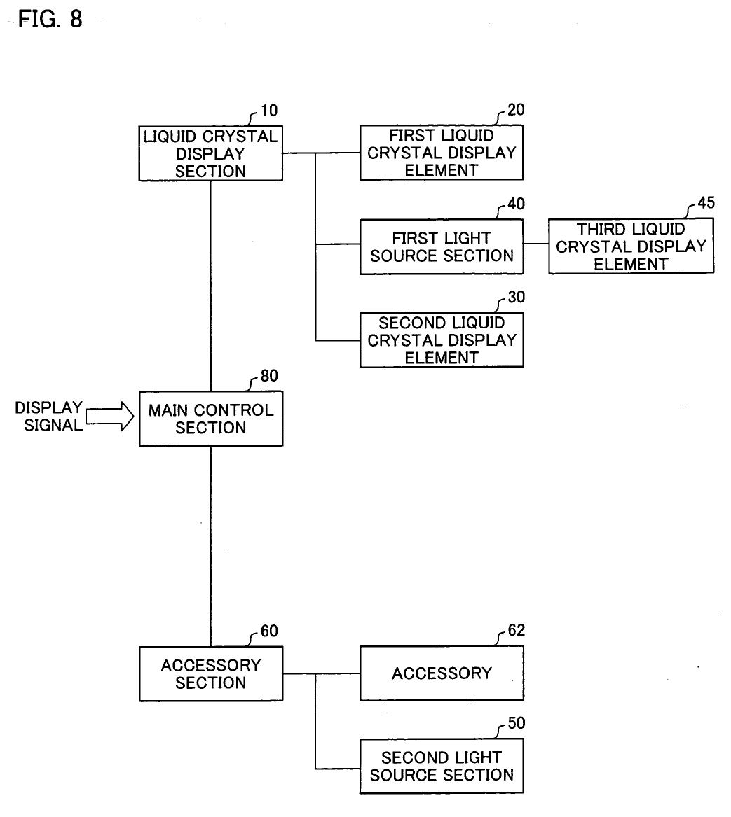

Next, a configuration of the liquid crystal display unit 1 of the present embodiment is described with reference to a block diagram. FIG. 8 is a block diagram schematically illustrating the configuration of the liquid crystal display unit 1 of the present embodiment.

As illustrated in FIG. 8, the liquid crystal display unit 1 of the present invention includes: the liquid crystal display section 10; the accessory section 60; and the main control section 80 for controlling the liquid crystal display section 10 and the accessory section 60. Further, the main control section 80 controls the liquid crystal display section 10 and the accessory section 60 in accordance with an incoming display signal. For example, the main control section 80 determines whether an accessory is to be displayed or not to be displayed in accordance with the display signal so as to control the liquid crystal display section 10 and the accessory section 60.

Specifically, the main control section 80 controls light emission and non-light emission of the second light source section 50 provided on the accessory section 60 in combination with the respective liquid crystal display elements (the first liquid crystal display element 20, the second liquid crystal display element 30, and the third liquid crystal display element 45) of the liquid crystal display section 10.

This makes it possible to carry out the aforementioned plural types of display.

### (Gaming Device)

The liquid crystal display unit 1 of the present embodiment can be used in various devices. For example, the liquid crystal display unit 1 can be favorably used in a gaming device, particularly, a pinball machine (pinball gaming device).

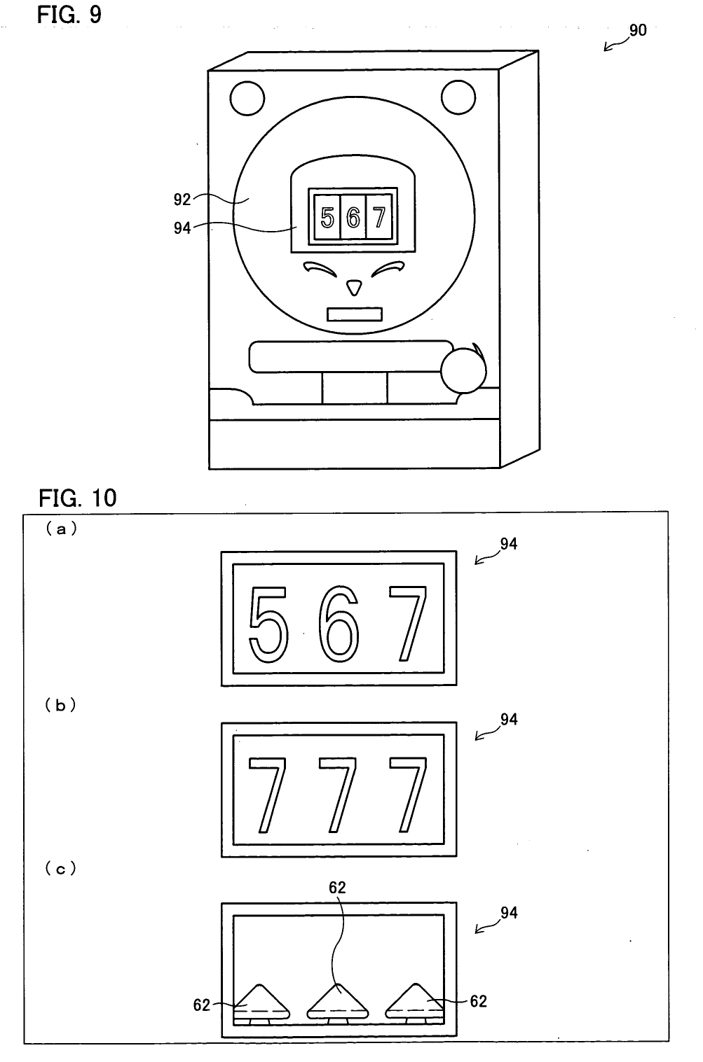

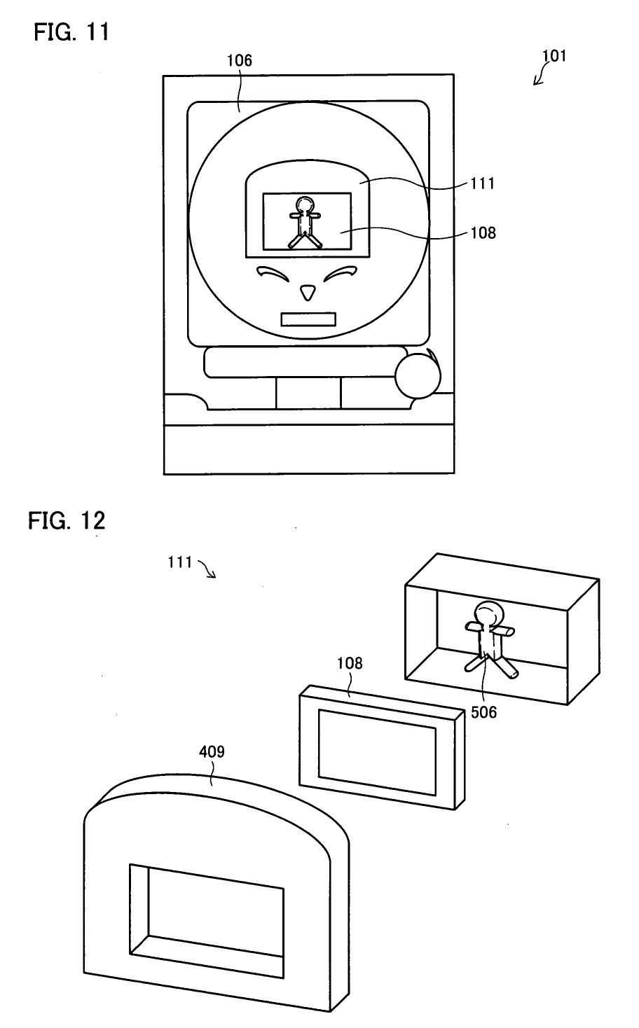

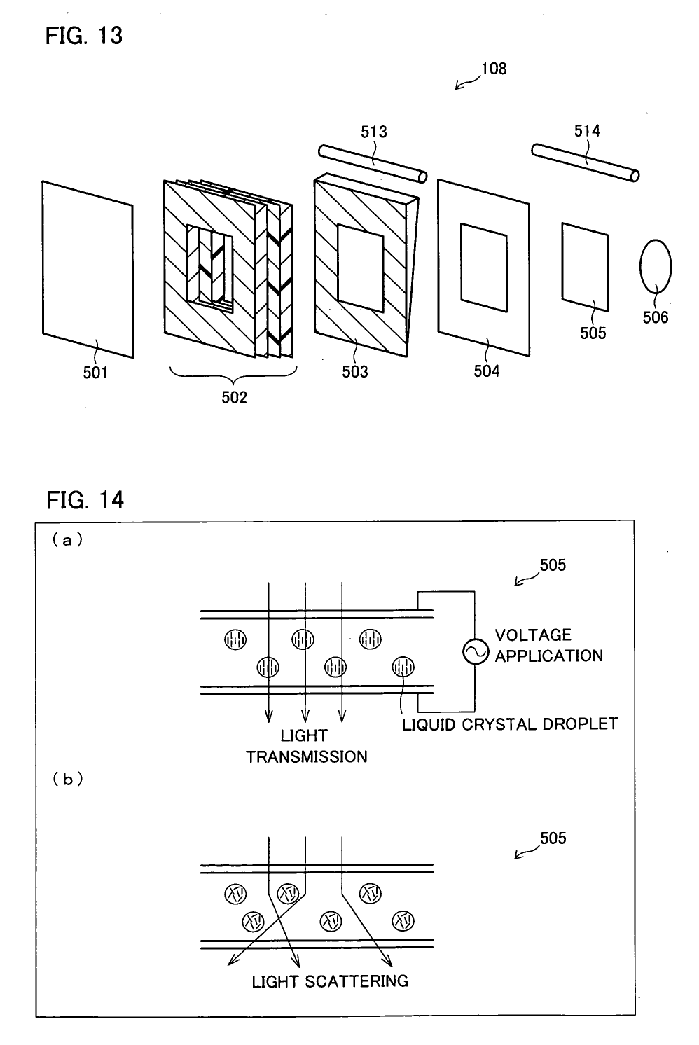

With reference to FIG. 9, the following gives some explanations. In a pinball machine which is an example of the gaming device 90 illustrated in FIG. 9, the liquid crystal display unit 1 can be used as an information display section 94 of a game panel 92.

In such a configuration, a player of the gaming device 90 is the observer V of the liquid crystal display unit 1, and the player can see, in the information display section 94, not only what the first liquid crystal display element and the third liquid crystal display element 45 display but also the accessories 62 positioned behind the information display section 94.

The present invention is not limited to the description of the embodiments above, but may be altered by a skilled person within the scope of the claims. An embodiment based on a proper combination of technical means disclosed in different embodiments is encompassed in the technical scope of the present invention.

### (Second Liquid Crystal Display Element)

For example, in the foregoing descriptions, the second liquid crystal display element, i.e., the shutter liquid crystal element for the accessories 62 was described taking the polymer dispersed liquid crystal element as an example. However, the second liquid crystal display element of the present invention is not limited to this configuration.

That is, the second liquid crystal display element may be configured in any manner as long as transmission and reflection of light can be controlled in accordance with switching between the display of the accessory and the non-display of the accessory. An example thereof is a general TN (Twisted Nematic) liquid crystal display element having a polarization plate. In case where the TN liquid crystal display element is used as the second liquid crystal display element, the accessories 62 can be more favorably shielded when the accessories are not displayed.

On the other hand, as described above, the polymer dispersed liquid crystal display element scatters and reflects light, and becomes bright in a light scattering state, so that what the first liquid crystal display element displays can be made brighter.

Further, the foregoing descriptions explained the configuration in which the second liquid crystal display element 30 serving as the shutter liquid crystal element is positioned behind the first liquid crystal display element 20. However, the configuration of the liquid crystal display unit 1 of the present invention is not limited to this configuration. For example, it may be so configured that the second liquid crystal display element 30 serving as the shutter liquid crystal element is not used.

That is, as described above, the liquid crystal display unit 1 of the present invention includes the light control layer 70 capable of controlling a visible state and an invisible state (shielded state and non-shielded state) of the accessories 62. Thus, also in the configuration having no shutter liquid crystal element, it is possible to switch between a visible state and an invisible state of the accessories 62 in carrying out a display.

### INDUSTRIAL APPLICABILITY

The liquid crystal display unit of the present invention can switch between a display of a video and a display of an accessory, so that the liquid crystal display unit is favorably applicable to an amusement equipment such as a gaming device.

1. A liquid crystal display unit, comprising:
a first liquid crystal display element for displaying an image; and
an accessory provided behind the first liquid crystal display element, wherein:
a light control layer is provided between the first liquid crystal display element and the accessory,
the light control layer separates two regions and transmits and reflects light so that a dark region of the two regions is not seen from a bright region of the two regions, while the bright region is seen from the dark region,
the two regions separated by the light control layer respectively include light sources whose brightnesses are independently controllable, and
said liquid crystal display unit includes a control section for controlling the brightnesses of the light sources.

2. The liquid crystal display unit as set forth in claim 1, wherein:
the light control layer reflects light traveling toward the light control layer from a region including the first liquid crystal display element, said region being one of the two regions separated by the light control layer, and
the light control layer allows light traveling toward the light control layer from a region including the accessory to pass through, said region being the other of the two regions separated by the light control layer.

3. The liquid crystal display unit as set forth in claim 1, wherein the light control layer is realized by a magic mirror.

4. The liquid crystal display unit as set forth in claim 1, wherein:
the light source provided in the region including the first liquid crystal display element is a first light source section serving as a backlight source of the first liquid crystal display element, and
the light source provided in the region including the accessory is a second light source section for illuminating the accessory.

5. The liquid crystal display unit as set forth in claim 4, wherein:
the first light source section is realized by a liquid crystal display element.

6. The liquid crystal display unit as set forth in claim 4, wherein:
the first light source section is realized by a surface light source.

7. The liquid crystal display unit as set forth in claim 1, wherein:
a second liquid crystal display element for shielding the accessory by means of optical means is provided between the first liquid crystal display element and the light control layer.

8. The liquid crystal display unit as set forth in claim 7, wherein:
the second liquid crystal display element is a polymer dispersed liquid crystal display element.

9. The liquid crystal display unit as set forth in claim 1, wherein:
an angle formed by the first liquid crystal display element and the light control layer is in a range of 40° to 50°.

10. A gaming device comprising a liquid crystal display unit as set forth in claim 1.

11. A display method of a liquid crystal display unit comprising:
a first liquid crystal display element for displaying an image;
an accessory provided behind the first liquid crystal display element;
a light control layer provided between the first liquid crystal display element and the accessory; and
light sources, respectively provided in two regions separated by the light control layer, whose brightnesses are independently controllable,
the light control layer controlling light so that a dark region of the two regions is not seen from a bright region of the two regions and the bright region is seen from the dark region,
